(19) United States
(12) Patent Application Publication
(10) Pub. No.: US 2008/0154011 A1
(43) Pub. Date: Jun. 26, 2008

(54) Opaque colored and white monofilaments having stability to prolonged exposure to UV light

(76) Inventors: Mingsong Wang, Shanghai (CN); Daniel Ayglon, Crozet (FR); Russel A. Brezler, Mineral Wells, WV (US); Austin H. Reid, Wilmington, DE (US); Immanuel Dayal Walker, Madurai (IN); Abdullah Zafar, Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/004,176

(22) Filed: Dec. 19, 2007

Related U.S. Application Data
(60) Provisional application No. 60/876,839, filed on Dec. 22, 2006.

(51) Int. Cl. C08G 73/00; C08G 63/00; A46B 1/00

(52) U.S. Cl. 528/271; 528/367; 15/167.1

(57) ABSTRACT

The present invention discloses opaque and white monofilaments that retain tensile strength even after exposure to high levels of UV light. Monofilaments of the present invention do not become brittle even after exposure to the equivalent of three to six months of Florida sun. Monofilaments of the present invention can be useful in brushes, filtration media, monofilament fabrics, synthetic hair for wigs, doll hair, and other applications where monofilaments can be used that are stored or sold in an environment where there is a substantial degree of exposure to the sun.

### CROSS-REFERENCE TO RELATED APPLICATION

This application claims the benefit of U.S. Provisional Application No. 60/876,839, filed Dec. 22, 2006, which is incorporated herein by reference in its entirety.

### FIELD OF THE INVENTION

The present invention relates to opaque and white monofilaments that can be used in a toothbrush. More particularly, the present invention relates to opaque and white monofilaments that have enhanced resistance to chemical, photo-, or heat-initiated degradation.

### BACKGROUND OF THE INVENTION

Filaments manufactured for use as toothbrush bristles are known, as are the methods of manufacture. For example, such bristles and manufacturing processes are described in: U.S. Pat. No. 6,090,488; U.S. Pat. No. 5,500,975; and, U.S. Pat. No. 5,533,227. Polyester and nylon are typically used in the manufacture of monofilaments for toothbrush applications. Nylon monofilaments particularly have superior mechanical properties, wear performance, splaying resistance, and chemical resistance. Generally, toothbrushes and other articles incorporating the type of filaments useful in the manufacture of toothbrushes, are packaged and sold under conditions which limit exposure to the elements. Particularly in the case of toothbrushes, storage and use of such articles are typically under controlled conditions, protected from exposure to heat, sun and weather. Thus, typically monofilaments used in toothbrush applications are not exposed to excessive UV light during their useful life—that is during storage, shipping, sale, and use. Further, the choice of monofilament polymer type can affect the degree of deterioration observed in a monofilament, and therefore not all monofilaments are susceptible to the effects of UV light to the point of not being useful.

Certain monofilaments, however, can become brittle after prolonged exposure to UV radiation with the result that their physical and mechanical properties deteriorate to the extent that they snap or break while being used for their intended purpose such as, for example, oral hygiene. The observed brittleness of the monofilaments can be attributed to loss of filament strength and flexibility. This property loss makes them undesirable for use in toothbrush applications or other applications where flexibility and strength are desirable. This loss of strength and flexibility can be attributed to degradation of the monofilaments upon exposure to unusually high levels of UV radiation, that is, levels of UV exposure not usual for toothbrushes.

For example, conventional nylon 66, nylon 6, nylon 610, nylon 612, nylon 614, and nylon 1010 monofilaments can become brittle upon exposure to prolonged UV radiation. This exposure can be equivalent to exposure to very sunny regions such as sun in Florida, USA. This degree of exposure can be encountered in some regions of the world where items are stored, marketed and/or sold in an outdoor environment and exposed to direct sunlight, such as can be the custom in certain Asian and Far East Asian countries. TiO₂, BaSO₄, CaO, ZnO, and ZnS are inorganic white pigments commonly used as photo-shields to increase the opacity of plastic articles, including monofilaments. However, surprisingly opaque and white monofilaments were found to be more susceptible to loss of strength and flexibility relative to natural or translucent filaments under such conditions. This is unexpected since light transmission through opaque or white monofilaments is reduced, and it could be expected that the effect of UV radiation would be reduced as well.

A conventional approach for improving the UV stability of a plastic article is to blend the plastic with a component that will impart UV-stability to the article. Different UV-stabilizers act by various mechanisms to provide UV-protected products. For example, UV-absorbers (or compounds convertible to UV absorbers), UV quenchers, UV-capturers, and photo-shields can impart increased stability to the effects of UV exposure, and collectively shall be considered herein as UV-stabilizers. Some inorganic compounds can function as photo-shields, but a loss in mechanical properties can be observed. Organic compounds, known conventionally as UV-stabilizers, can impart resistance to degradation from exposure to UV light. Conventionally known UV-stabilizers include: p-tert-Butylphenyl salicylate; p-Octylphenyl salicylate; p,p′-Isopropylidene-bis(phenol salicylate); 2-Hydroxy-4-methoxy-benzophenone; 2-Hydroxy-4-n-octoxy-benzophenone; 2-(2′-Hydroxy-5′-methlyphenyl)benzotriazole; 2-(3′-tert-Butyl-2′-hydroxy-5′-methyl phenyl)-5-chlorobenzo triazole; Nickel N,N-di-n-butyl dithiocarbamate; and 2,2′-thiobis(p-tert-octylphenolate)nickel, for example.

However, in the case of toothbrushes or other items that can be used in personal care, concerns about limited robustness under typical process conditions and migration may make use of certain organic UV-stabilizers undesirable. An optimum candidate for use as a UV stabilizer in a toothbrush bristle application should:
(a) provide effective protection from ultraviolet rays ranging from 290-410 nm;
(b) provide effective protection even after long term exposure to UV radiation;
(c) possess excellent heat stability to high temperature processing;
(d) be compatible with monofilament polymer, with no or little migration during processing;
(e) have low volatility;
(f) have low toxicity or no toxicity and, if necessary, be suitable for uses where direct or indirect food contact is anticipated;
(g) have good chemical resistance;
(h) cause no substantial deleterious effect to the physical or mechanical properties of the monofilaments; and,
(i) have adequate resistance to hydrolysis and aqueous extraction.

An organic UV stabilizer may contain compounds with complex chemical structures that are not recommended for use in oral care or personal care applications. Therefore, filaments that include conventional organic UV stabilizers may not be useful in such applications.

While all monofilaments do not require a UV-attenuating component to retain desirable properties after prolonged exposure to UV light, some monofilaments can lose their desirable properties. It can, therefore, be desirable to include a non-organic UV-stabilizer that can be safely used in personal care products such as toothbrushes or other such products that can deteriorate when exposed to UV-radiation. It can be particularly desirable to use monofilaments having opaque or white coloration that can withstand conditions of high heat, humidity, and prolonged exposure to sunlight with no substantial degradation or loss of filament strength.

### SUMMARY OF THE INVENTION

Disclosed herein is a brush comprising: (i) a handle; (ii) a brush head distal to the handle; and (iii) a plurality of opaque white synthetic monofilaments, wherein the monofilaments comprise about 0.5 wt % or less of a UV-attenuating component and wherein the monofilaments, on average, retain at least about 65% of their initial strength and flexibility when tested according to ASTM G26.

Also disclosed herein is a brush comprising: (i) a handle; (ii) a brush head distal to the handle; and (iii) plurality of opaque colored synthetic monofilaments, wherein the monofilaments comprise about 0.5 wt % or less of a UV-attenuating component and wherein the monofilaments, on average, retain at least about 70% of their initial strength and flexibility when tested according to ASTM G26. Still another disclosure herein is opaque colored synthetic monofilament, wherein the monofilament comprises about 0.5 wt % or less of a UV-attenuating component and wherein the monofilament retains at least about 70% of its initial strength and flexibility when tested according to ASTM G26.

Another disclosure herein is opaque white synthetic monofilament, wherein the monofilament comprises about 0.5 wt % or less of a UV-attenuating component and wherein the monofilament retains at least about 70% of its initial strength and flexibility when tested according to ASTM G26.

### DETAILED DESCRIPTION OF THE INVENTION

In one embodiment, the present invention is an opaque, white or colored monofilament that resists degradation, as evidenced by retention of tensile strength even after prolonged exposure to high levels of UV radiation.

A monofilament of the present invention is a synthetic monofilament and can be obtained by conventional processes from plastic materials such as nylon and nylon copolymers, polyesters, and polyolefins.

More specifically, nylons such as nylon 66, nylon 612, nylon 610, nylon 614, nylon 6, and nylon 1010, or blends thereof, can be useful in the practice of the present invention.

Alternatively, polyesters such as polyethylene terephthalate (PET), polybutylene terephthalate (PBT), polytrimethylene terephthalate (PTT), and polycyclohexylene dimethylene terephthalate (PCT) can be useful in the practice of the present invention.

Polyolefins may also be useful in the practice of the present invention. It can be conventional to blend polymers that are compatible and which blends can provide enhanced or modified polymer properties to the final polymeric product.

Blends of polymeric materials that are known to be useful as monofilaments for toothbrushes or similar applications are considered to be within the teachings of the present invention.

Preferred polymers have molecular weights (MW) exceeding 10,000 and typically consist of polyamides (nylon 6,12; nylon 6,10; nylon 6, nylon 10,10; nylon 6,6; nylon 6,14; wherein the polyamide is a homopolymer, copolymer, or blend thereof, polyesters (polybutylene terephthalate, polyethylene terephthalate, polytrimethylene terephthalate), and polyolefins such as polypropylene or polybutylene, or blends thereof.

A monofilament of the present invention comprises at least one UV-attenuating component that reduces the level of UV light transmitted through the monofilament. The UV-attenuating component can be an opacifier or a pigment. Particularly, monofilaments of the present invention comprise at least one UV-attenuating pigment that has been engineered to reduce the degradation of said monofilaments upon prolonged exposure to UV light. Examples of such pigments include: titanium dioxide (TiO₂); zinc oxide (ZnO); zinc sulfide (ZnS); and, cerium oxide (CeO₂) particles, or mixtures of any of these. Preferably the pigment is TiO₂ or ZnO, most preferably the pigment is TiO₂. The degree of UV attenuation by the particles can depend on such factors as the particle size, the particle design, and the particle composition. Nanoparticles of titanium dioxide, zinc oxide, and cerium oxide can be useful in attenuating the effects of UV radiation on monofilaments of the present invention. It has been found that pigment nanoparticles can provide approximately twice the UV attenuation as the same amount, on a weight percentage basis, as non-nano-sized UV-attenuating pigment particles.

For the purposes of the present invention, particle sizes of pigments useful in the practice of the present invention can be less than 400 nm, and can range from about 50 nm to about 400 nm. Nanoparticles, for the purposes of the present invention, are particles having an average particle size of less than or equal to about 200 nm, preferably from about 75 to about 180 nm, and more preferably from about 75 to about 160 nm. “Normal” sized pigment particles, for the purposes of the present invention, are pigment particles of greater than about 200 nm.

UV-attenuating pigments of the present invention having a size of 200 nm or less can require engineering to be more effective in the practice of the present invention. The surface of such UV-attenuating nanoparticles can be modified with, for example: alumina; silica; or anions such as sulfates, chlorides, nitrates, and phosphates, for example.

A monofilament of the present invention comprises about 0.5 wt % or less UV-attenuating pigments. Preferably, said pigments are included in the monofilament in an amount of from about 0.1 to about 0.5 wt %, based on the weight of the monofilament. More preferably, said monofilaments comprise from about 0.1 to about 0.4 wt % of said pigments. Optionally, other pigments can be included in the monofilament to provide various opaque colorations. For example, blue, green, yellow, orange, red or other colors can be obtained using known pigments such as: Pigment Black 7, C177266; Channel Black; Pigment Blue 15, C174160; Phthalocyanine Blue; Pigment Green 7; C174260; Phthalocyanine Green; Pigment Red 101; C177491; Iron Oxide; Pigment Violet 15; C177007; Ultramarine Violet; Pigment Yellow 100; C119140; and FD&C Yellow #5 Lake.

These pigments can be combined individually with the UV-attenuating pigment, or can be used in various combinations, provided that such pigments are considered safe for use in toothbrushes and/or other consumer brush applications. Such other optional pigments can be included in any effective amount that can provide the desired coloration, but preferably the total percentage, by weight, of the optional and UV-attenuating pigments together is 0.75 wt % or less of the monofilament composition.

Monofilaments of the present invention have minimum diameters of 0.003 inch and maximum diameters from 0.020 inch and can be produced using conventional or known processes, such as: extruding a molten polymeric material through a single or twin screw extruder and/or cascade of static mixers, using a spinnerette plate to produce filaments, quenching the filaments, drawing the filaments, annealing the filaments, and assembling the filaments into a hank (e.g. bundle of filaments). The filaments can be drawn to provide a filament with a flex modulus of 400 Kpsi to 2,000 Kpsi depending on the properties of the polymeric material used.

Filaments can be produced in any color by blending in different colorants or color concentrates. Also, different cross-sectional shapes such as hollow, trilocular, tetralocular, quadrilobal and hexagonal can be produced by extruding through different capillary shapes. Filaments of the present invention can comprise a variety of additives such as, but not limited to, clays, Teflon® micropowders, metal powders, abrasive grits, metal particles, and antimicrobial ingredients.

After the filaments are assembled into hanks, the hanks are cut into pieces of certain lengths. The cut pieces can be used for toothbrushes or other brushes using standard tufting processes.

In addition to toothbrushes, monofilaments of the present invention can be used in applications such as abrasive filaments, cosmetics (e.g., cosmetic brushes), paintbrushes, calligraphy brushes, filtration media, monofilament fabrics, synthetic hair for wigs, doll hair, and other applications where monofilaments can be used.

Monofilaments of the present invention exhibit less loss of strength and/or flexibility, as measured by break load, after prolonged exposure to UV radiation than certain conventional monofilaments. For the purposes of the present invention, “prolonged exposure to UV radiation” means that a sample monofilament has been exposed to UV radiation for a period of time in the range of from 500 to 800 hours, which should approximate 12 weeks of exposure to sunlight, under conditions of less than about 50% relative humidity, according to ASTM G26. Monofilaments of the present invention exhibit a % loss of break load (BL)—herein defined as: “the measured BL (BLₘ) minus the initial BL (BLᵢ) divided by BL multiplied by 100%”—is the absolute value of 35% or less. In other words, an opaque white monofilament of the present invention retains at least about 65% or more of its strength, as exemplified by break load measured under the conditions described herein. Preferably the monofilament retains at least about 70% of its strength, and more preferably at least about 75% of its strength.

In another embodiment, a colored UV-attenuating monofilament of the present invention comprising a UV-attenuating pigment and additionally comprising a colored pigment has a % loss of break load which is less than or equal to the absolute value of 25%, when determined according to the procedures described herein.

In still another embodiment, the monofilament tips can be tapered or angled by processes known in the art such as, for example, by dipping an end portion of a monofilament in hot-caustic solution and removing the monofilament from the solution, followed by neutralization of residual caustic on the monofilament and rinsing the monofilament to obtain a monofilament having a tapered diameter at the end portion.

### EXAMPLES

### Example 1

Nylon 6,10 resin (commercially available from DuPont Xingda Filaments Co., Ltd. in Wuxi, Jiangsu, China) was blended with TiO₂ (DuPont DPX-Opt 1) at 0.413% by weight to obtain a white blend. Certain percentage of the wetting agent, which was white oil with food contact, at about 0.06-0.10%) was applied in order for the resin to absorb the powders onto its surface and make the powders more homogeneously distributed.

A 120 hole spinneret plate with 0.08 mm diameter round holes was installed in the spinner and the nylon blend was extruded at temperatures ranging from 215 to 320° C. and quenched in a water bath (bath temperature ranging from 12 to 35° C.). The resulting strands were drawn to obtain filaments with a uniform diameter and with desirable strength after pulling through a heating bath at a temperature ranging from 80 to 100° C. The draw ratio ranges from 3.2 to 4.6. The fixed filaments were thermo-set with 15 MPa saturated steam for 25 to 60 minutes on a winding frame. The filaments were checked and wrapped into long hanks or cut into smaller pieces.

A set of filament samples of 30 cm length were tested according to ASTM G26, with the exception that the samples were not sprayed with water during the test, over a period of 26 days.

Average break loads for ten sample were obtained using an Instron tester. Table 1 shows the results of the UV exposure test. Commercially available filaments were obtained and tested for comparison according to the same analytical procedures. The results are also shown in Table 1. The Comparative Filaments are white opaque nylon 610 filaments that include conventional titanium dioxide pigment at 0.33% wt %.

TABLE 1

| | | Loss of break |
|---|---|---|
| | Break load, N (days exposed) | load, % |
| Comparative Ex 1 | 12.65 (0) | 0 |
| | 7.00 (26) | −45% |
| Example 1 | 11.54 (0) | 0 |
| | 8.61 (26) | −25% |
| Comparative Ex 2 | 12.65 (0) | 0 |
| | 7.00 (26) | −45% |
| Example 2 | 12.25 | 0 |
| | 8.43 | −31% |
| Comparative Ex 3 | 12.32 | 0 |
| | 8.24 | −33% |
| Example 3 | 14.54 | 0 |
| | 11.66 | −20% |

The data show that the rate of loss of break load for the filaments of Example 1 is less than the comparative examples in the same duration of time, which indicates that the filaments of the present invention are more robust than conventional filaments against weathering caused by exposure to UV radiation.

### Example 2

The white color filaments of Example 2 were produced using the same process and test conditions as described in Example 1 by adjusting the loading percentage of TiO₂ to 0.231%. Commercially available filaments were tested for comparison, and the results are shown in Table 1.

### Example 3

Blue opaque filaments of Example 3 were produced using the process and test conditions as described in Example 1, except that blue pigment (phthalocyanine blue, 0.005%) was added along with 0.0999% TiO2 by weight, to obtain the following results shown in Table 1. The same blue pigment is used in the comparative sample.

What is claimed is:

1. A brush comprising:
a. a handle;
b. a brush head distal to the handle; and
c. a plurality of opaque white synthetic monofilaments, wherein the monofilaments comprise about 0.5 wt % or less of a UV-attenuating component and wherein the monofilaments, on average, retain at least about 65% of their initial strength and flexibility when tested according to ASTM G26.

2. A tuft for use in a brush of claim 1 comprising a plurality of synthetic monofilaments wherein the monofilaments comprise about 0.5 wt % or less of a UV-attenuating component and wherein the monofilaments retain at least about 65% of their initial strength and flexibility when tested according to ASTM G26.

3. The brush of claim 1, wherein the brush is a toothbrush, paintbrush, cosmetic brush, or calligraphy brush.

4. An opaque white synthetic monofilament, wherein the monofilament comprises about 0.5 wt % or less of a UV-attenuating component and wherein the monofilament retains at least about 65% of its initial strength and flexibility when tested according to ASTM G26.

5. The monofilament of claim 4 wherein the monofilament comprises a polymer selected from the group consisting of: nylon 6; nylon 66; nylon 610; nylon 612; nylon 614; nylon 1010; polyesters; polyolefins or blends thereof.

6. The monofilament of claim 5 wherein the UV-attenuating component is a pigment having a particle size of 400 nm or less.

7. The monofilament of claim 6 wherein the UV-attenuating pigment is selected from the group consisting of titanium dioxide, zinc oxide, zinc sulfide, and cerium oxide.

8. The monofilament of claim 7 wherein the UV-attenuating pigment has a particle size of less than or equal to about 200 nm.

9. Abrasive filaments, cosmetics, paintbrushes, calligraphy brushes, filtration media, monofilament fabrics, synthetic hair for wigs, or doll hair comprising the monofilament of claim 4.

10. A brush comprising:
(i) a handle; (ii) a brush head distal to the handle; and (iii) plurality of opaque colored synthetic monofilaments, wherein the monofilaments comprise about 0.5 wt % or less of a UV-attenuating component and wherein the monofilaments, on average, retain at least about 70% of their initial strength and flexibility when tested according to ASTM G26.

11. A tuft for use in a brush of claim 10 comprising a plurality of synthetic monofilaments wherein the monofilaments comprise about 0.5 wt % or less of a UV-attenuating component and wherein the monofilaments retain at least about 70% of their initial strength and flexibility when tested according to ASTM G26.

12. The brush of claim 10, wherein the brush is a toothbrush, paintbrush, cosmetic brush, or calligraphy brush.

13. An opaque colored synthetic monofilament, wherein the monofilament comprises about 0.5 wt % or less of a UV-attenuating component and wherein the monofilament retains at least about 70% of its initial strength and flexibility when tested according to ASTM G26.

14. The monofilament of claim 13 wherein the monofilament comprises a polymer selected from the group consisting of: nylon 6; nylon 66; nylon 610; nylon 612; nylon 614; nylon 1010; polyesters; polyolefins or blends thereof.

15. The monofilament of claim 13 wherein the UV-attenuating component is a pigment having a particle size of 400 nm or less.

16. The monofilament of claim 15 wherein the UV-attenuating pigment is selected from the group consisting of titanium dioxide, zinc oxide, zinc sulfide, and cerium oxide.

17. The monofilament of claim 16 wherein the UV-attenuating pigment has a particle size of less than or equal to about 200 nm.

18. Abrasive filaments, cosmetics, paintbrushes, calligraphy brushes, filtration media, monofilament fabrics, synthetic hair for wigs, or doll hair comprising the monofilament of claim 13.
